(19) United States
(12) Patent Application Publication
(10) Pub. No.: US 2003/0173716 A1
(43) Pub. Date: Sep. 18, 2003

(54) Digital printing system for printing colored polyolefin films

(76) Inventor: Pang-Chia Lu, Pittsford, NY (US)

Correspondence Address: EXXONMOBIL CHEMICAL COMPANY, P O BOX 2149, BAYTOWN, TX, 77522-2149, US

(21) Appl. No.: 10/074,635

(22) Filed: Feb. 13, 2002

(51) Int. Cl. B29C 47/00

(52) U.S. Cl. 264/495; 264/132; 264/173.18; 264/173.19; 264/210.7

(57) ABSTRACT

A colored polyolefin film is printed by digital printing techniques. The colored polyolefin film is formed by blending a coloring agent, such as a pigment or a dye, with a polyolefin, and forming a film from the blend by an extrusion process. Digital signals are supplied to a printer adapted to respond to such signals to print the colored film. Indicia may be placed on the surface of the colored film by electrostatic printing, thermal transfer printing or ink jet printing, especially with an ultraviolet (UV) curable ink jet ink. The colored polyolefin film may be a multi-layer film having an opaque, cavitated core layer and at least one colored skin or tie layer.

### BACKGROUND

Colored polyolefin films can be printed with digital printing techniques to give unique optical effects. A particular type of digital printing involves digitally controlled ultraviolet (UV) ink jet printing.

Paper in various colors, including white, may provide a suitable substrate for printing. In particular, paper is opaque and receptive to a variety of printing inks.

In many applications, polymeric film materials are preferred to paper. For example, polymeric films can provide one or more of the following properties lacking in paper, such as durability, strength, water resistance, curl resistance, abrasion resistance, gloss and other properties. Many polymeric films, however, are not suitable for use as printing substrates, particularly in view of a lack of opacity and a lack of receptivity to printing inks.

U.S. Pat. No. 4,377,616 discloses an opaque, biaxially oriented polymeric film structure of lustrous satin appearance comprising a thermoplastic core matrix having a strata of voids; said voids being created by the inclusion within the matrix material of spherical void-initiating solid particles which are incompatible with the matrix material. The void space occupied by the particle is substantially less than the volume of the void. The polymeric matrix material is extruded in the form of a film. Void free, transparent thermoplastic skin layers are positioned on opposite surfaces of the film. The structure has excellent opacity and extremely high gloss measurement and a lustrous satin appearance.

Opaque, biaxially oriented polymeric film structures are also described in U.S. Pat. Nos. 4,632,869; 5,176,954; and 5,397,635.

U.S. Pat. No. 5,972,490 discloses a biaxially oriented polyolefin film comprising a core layer of propylene polymer, an intermediate layer of a non-voided, substantially non-pigmented propylene polymer on the core layer, and an outer skin layer of a polyolefin including titanium dioxide as a pigment.

U.S. Pat. No. 4,758,462 discloses an opaque, biaxially oriented film structure which comprises an expanded thermoplastic polymer matrix core layer within which is located a minor amount of a light-absorbing pigment and a strata of voids.

In the packaging of certain types of foods, such as snack foods like potato chips, cookies and the like, one or more colors may be printed onto the film packaging. A desirable property in such a packaging film is bright coloring with a pleasing aesthetic appearance.

U.S. Pat. No. 4,536,184 discloses overprinting a poly(vinyl chloride) resin substrate whose surface, or portion thereof, is colored by solvent soluble dye or by way of a mass solvent soluble dye, with a coloring agent made up of a liquid halogenated hydrocarbon solvent having 1-4 carbon atoms, pigment dispersed in said halohydrocarbon solvent, and a film former, dissolved in said halohydrocarbon solvent, consisting essentially of (a) acrylic resin or (b) a combination of acrylic resin and chlorinated polyolefin, at least 50% by weight of acrylic resin; and heat treating said overprinted substrate to adhere said film former and associated pigment.

U.S. Pat. No. 5,683,805 discloses a colored film formed of a transparent film and at least one colored adhesive layer arranged on one side of the transparent film. The adhesive layer has been colored by a colorant composed of a pigment and a dispersant. The dispersant comprises a (meth)acrylate ester polymer formed, as essential monomer components, of an aromatic vinyl monomer, a primary to tertiary amino-containing (meth)acrylate ester monomer and a (meth)acrylate ester monomer containing an ammonium group quatemized with an aromatic compound.

Copending U.S. application Ser. No. 09/757,175, filed Jan. 9, 2001, which is a continuation-in-part of copending U.S. application Ser. No. 09/749,421, filed Dec. 19, 2000, describes coextruded films made of multiple layers of thermoplastics, wherein at least one of the layers is colored using a coloring agent, and at least one of the remaining layers is opaque. These colored films have high opacity and low light transmission, especially in the UV and blue wavelengths. These colored films may be bonded to a wide variety of substrates and coatings.

### SUMMARY

A method for printing a polyolefin film comprising the steps of:

(a) blending a coloring agent with a polyolefin;

(b) extruding said blend of step (a) onto a casting roll to form a colored extruded film;

(c) orienting said colored extruded film of step (b) in at least one direction to form an oriented film;

(d) passing said oriented film of step (c) to a digital printer; and

(e) passing a digital signal to said digital printer to cause indicia to be placed on the surface of said oriented film.

### BRIEF DESCRIPTION OF THE DRAWINGS

FIG. 1 is a schematic diagram of a method for determining percent light transmission.

FIG. 2 is a schematic diagram of a method for determining percent opacity.

FIG. 3 is a cross sectional view of a five layered colored film.

FIG. 4 is a cross sectional view of a three layered colored film.

FIG. 5 is a cross sectional view of a four layered colored film.

FIG. 6 is a cross sectional view of a two layered colored film.

### DETAILED DESCRIPTION

In accordance with the present film, coloring agent is incorporated directly within the film structure during the film forming process. An advantage to this type of incorporation, as opposed to merely applying a colored coating to an uncolored film, is the uniformity and consistency of the base colors in the film.

For the purposes of embodiments described herein, it will be understood that terms used herein involving the word “print”, including “printing”, “printer” and “printed”, connote the application of indicia of any form onto a surface. Such indicia include, but are not limited to: letters; numbers; shapes; and pictures (e.g., of people, structures and other objects). Such indicia may be in the form of a single color (e.g., black) or in the form of multiple colors.

A particularly suitable colored film printing substrate is described in the above-mentioned U.S. application Ser. No. 09/757,175. An example of such a film is an opaque, biaxially oriented polymeric film with an inner core containing numerous microscopic voids and at least about 1% by weight of void initiating or opacifying compounds and/or particles; a first intermediate layer on one surface of the core layer, containing a coloring agent; a first skin layer on the outside of the first intermediate layer which may or may not contain a coloring agent; a second intermediate layer on the other surface of the core layer and a second skin layer on the outside of the second intermediate layer. The second intermediate layer and/or the second skin layer may or may not contain a coloring agent.

When relatively low concentrations of the coloring agents are used, the film of U.S. application Ser. No. 09/757,175 offers a deep and vibrant color. This results from a comparatively large portion of the incident light reaching the opaque inner core where it is reflected or refracted back through the first intermediate layer containing a coloring agent; without too much scattering. The film offers good protection against light going through the film, with an opacity greater than 60%, and light transmission less than 40% in the wavelength range of from 250 nm to 500 nm which is particularly damaging to a packaged food product.

The configuration of the layers described in U.S. application Ser. No. 09/757,175 offers great flexibility and economy in achieving desired film characteristics. The first intermediate and skin layers which may be on a package exterior allow optimum protection against water vapor transmission and a vibrantly colored surface which can be printed. The inner core layer has all the advantages of cavitation with protection against light transmission. The second intermediate layer can also be colored with the same or a different color for a film with the same or different colors on each side. The second skin layer can be a simple, economical thin encapsulating layer or it can be a more elaborate heat sealable layer.

The composition of the layers described in U.S. application Ser. No. 09/757,175 can allow for a differential appearance when viewed from the first skin layer or when viewed from the second skin layer. A first color will be viewed on the first skin layer together with any printing or other modifications. A second color can be viewed on the second skin layer together with different printing or modifications. The appearance from the second skin layer can be a plain white which would be suitable for the inside of a food package.

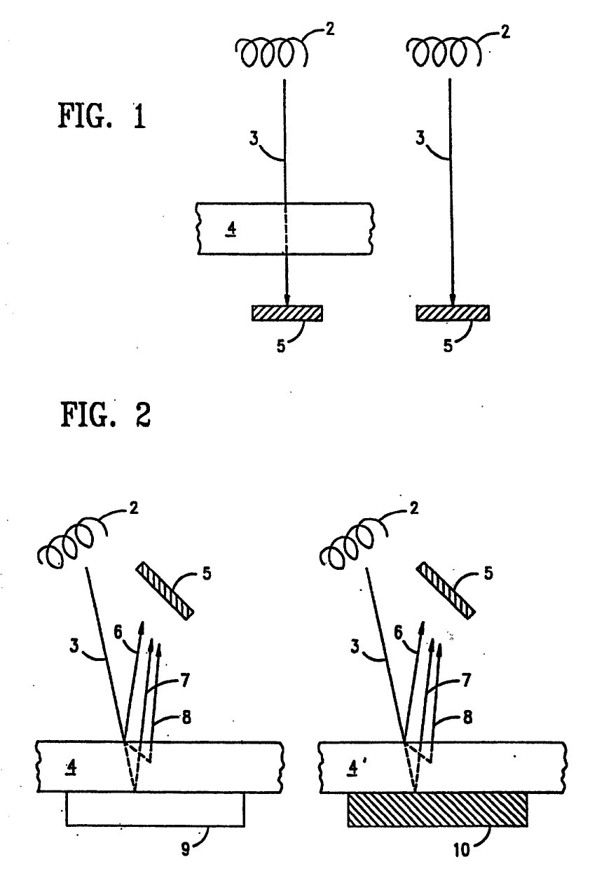

FIG. 1, shows how the percent light transmission through a film is determined by using light source 2 to transmit light rays 3 directly through film 4 and measuring at light sensor 5, value T₂ which is the amount of light rays 3 which is transmitted through film 4. The amount of light rays 3 which can be directly transmitted, value T₁, is determined by measuring the light rays 3 directly transmitted by light source 2 with no intervening film. The percent light transmission through the film can then be determined using the formula:

% Light Transmission=T₂/T₁*100

Referring now to FIG. 2, for a measure of percent opacity of a film, light source 2 transmits light rays 3 through film 4 onto a white surface 9 and the same procedure used to project light onto a black surface 10. With both white and black surfaces, measurement at light sensor 5 is of all of the following: light reflected off the upper surface of the film 6; light transmitted through the film and reflected by the white surface 9 or black surfaces 10 on the side of the film opposite from the light source 7; and, light scattered by the film 8.

The percent opacity of the film can then be determined using the formula:

% Opacity=100*R_{B}/R_{W}

where

R_{W}=Reflected light+scattered light+light transmitted through the film and

reflected off a white surface; and

R_{B}=Reflected light+scattered light+light transmitted through the film and reflected off a black surface.

Accordingly, a highly reflective film may provide high opacity while allowing light transmission. This is because percent light transmission is not the equivalent of percent opacity.

Light transmission is the amount of light passing directly through the film. To prevent food spoilage decreased light transmission is desirable. Prevention of light transmission in shorter UV wavelengths up to 400 nm and the blue-violet range of from 400 to 450 nm is particularly desirable for this purpose.

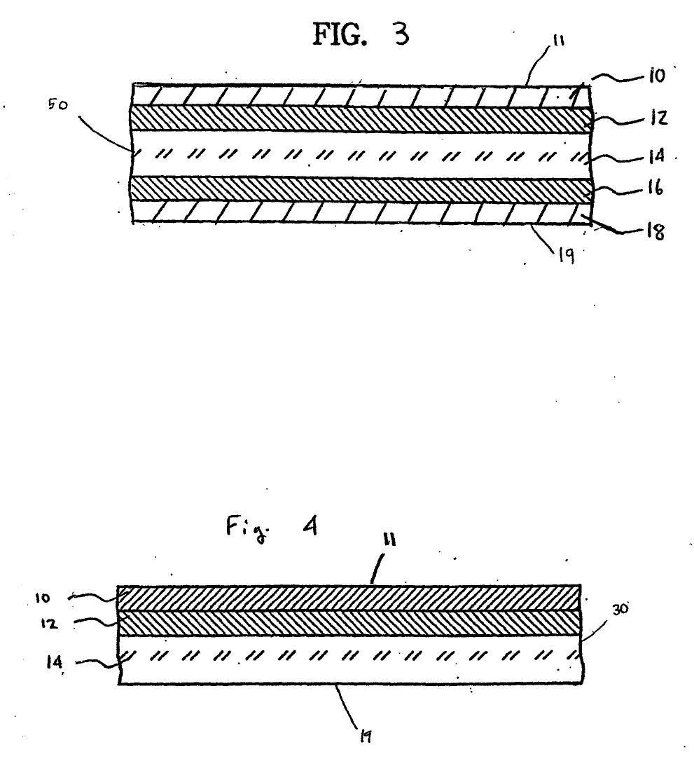

FIG. 3 is a cross sectional view of a five layered colored film 50. The film 50 is comprised of a first surface 11, a first skin layer 10, a first intermediate or transition layer 12, an opaque core layer 14, a second intermediate or transition layer 16, a second skin layer 18, and a second surface 19.

In one embodiment of a five layered film 50, the first skin layer 10 and/or the first transition layer 12 can be colored by a coloring agent. The percent light transmission of the combination of the first skin layer 10 and the first transition layer 12 is relatively high, in one embodiment from 50-99%, in another embodiment from 65-97% and in a third embodiment from 75-95%. Additionally the percent opacity of the combination of the first skin layer 10 and the first transition layer 12 is relatively low, in one embodiment from 1-50%, in another embodiment from 3-40% and in a third embodiment from 5-25%. This combination of low opacity and high light transmission allows the light to enter the first surface 11 travel through the first skin layer 10 and the first transition layer 12 and reach the opaque core layer 14 from where it is reflected and travels back through the first transition layer 12 and the first skin layer 10 to reach the first surface 11 and provide for deep and vibrant color. In this embodiment, the percent light transmission of the film 50 is relatively low, in one embodiment from 0-30%, in another embodiment from 0-20% and in a third embodiment from 0-10%. Additionally the percent opacity of the film 50 is relatively high, in one embodiment from 50-100%, in another embodiment from 75-100% and in a third embodiment from 90-100%. This combination of low light transmission and high opacity for the film 50 provides a desirable packaging material which protects the packaged product from deterioration caused by exposure to light.

In a second embodiment, the first skin layer 10 and/or the first transition layer 12 can be colored by a coloring agent as in the first embodiment, and the second skin layer 18 and/or the second transition layer 16 can also be colored by a coloring agent as in the first embodiment. This film 50 allows for one deep and vibrant color to be seen on the first surface 11 and the same or a different deep and vibrant color to be seen on the second surface 19. In this embodiment, the percent light transmission of the film 50 is relatively low, in one embodiment from 0-30%, in another embodiment from 0-20% and in a third embodiment from 0-10%. Additionally the percent opacity of the film 50 is relatively high, in one embodiment from 50-100%, in another embodiment from 75-100% and in a third embodiment from 90-100%. This combination of low light transmission and high opacity for the film 50 provides a desirable packaging material which protects the packaged product from deterioration caused by exposure to light.

In a third embodiment of a five layered film 50, the first skin layer 10 is essentially transparent and the first transition layer 12 is colored by a coloring agent. Additionally, the first surface 11 on top of the first skin layer 10 an image is printed. The percent light transmission of the first transition layer 12 is relatively high, in one embodiment from 50-99%, in another embodiment from 65-90% and in a third embodiment from 75-85%. Additionally the percent opacity of the first transition layer 12 is relatively low, in one embodiment from 1-50%, in another embodiment from 5-40% and in a third embodiment from 10-25%. This combination of low opacity and high light transmission allows the light to enter the first surface 11 travel through the first skin layer 10 and the first transition layer 12 and reach the opaque core layer 14 from where it is reflected and travels back through the first transition layer 12 and the first skin layer 10 to reach the first surface 11 and provide for deep and vibrant color and produces a 3-D effect which makes the printed image appear to float on top of the film 50. In this embodiment, the percent light transmission of the film 50 is relatively low, in one embodiment from 0-30%, in another embodiment from 0-20% and in a third embodiment from 0-10%. Additionally the percent opacity of the film 50 is relatively high, in one embodiment from 50-100%, in another embodiment from 75-100% and in a third embodiment from 90-100%. This combination of low light transmission and high opacity for the film 50 provides a desirable packaging material which protects the packaged product from deterioration caused by exposure to light. An image may be digitally printed on the first surface 11, a first skin layer 10 made of polyethylene, a first transition layer 12 made of a colored polypropylene, a core layer 14 made of cavitated polypropylene, a second transition layer 16 made of polypropylene, and a second skin layer 18 made of polypropylene.

In a fourth embodiment of a five layered film 50, inorganic additives are added to the first skin layer 10 to impart a rough low-gloss paper-like feel to the first surface 11 to simulate Kraft paper. The first transition layer 12 is colored by a coloring agent, with a sufficient amount of coloring agent to yield a brown kraft paper color. Additionally, the second skin layer 18 preferably has inorganic additives added to impart a rough low-gloss paper-like feel to the second surface 19 to simulate kraft paper. The second transition layer 16 may be colored by a coloring agent, with a sufficient amount of coloring agent which could be white. One variation of the fourth embodiment has a first surface 11 with a brown coloring and a rough low-gloss paper-like feel and a second surface 19 with a white coloring and a rough low-gloss paper-like feel. In this embodiment, the percent light transmission of the film 50 is relatively low, in one embodiment from 0-30%, in another embodiment from 0-20% and in a third embodiment from 0-10%. Additionally the percent opacity of the film 50 is relatively high, in one embodiment from 50-100%, in another embodiment from 75-100% and in a third embodiment from 90-100%. This combination of low light transmission and high opacity for the film 50 provides a desirable packaging material which protects the packaged product from deterioration caused by exposure to light.

A fifth embodiment has a first skin layer 10 made of an EP impact copolymer or blend of incompatible resins such as PP homopolymer, EP copolymer, EPB terpolymer, HDPE, or LDPE copolymer, and addition of CaCO₃, talc, and SiO₂. In one variation of the fifth, the first skin layer 10 is 0.5 to 3.0 microns thick. The first transition layer 12 is brown colored and made of as PP homopolymer, EP random copolymer, PB copolymer, EPB terpolymer, HDPE, LLDPE, or MDPE with a blend of iron oxide, carbon black, and TiO₂. In another variation, the first transition layer 12 is 1 to 7 microns thick. In a third variation, the core layer 14 is made of an isotactic cavitated polypropylene and is 5 to 50 microns thick. The second transition layer 16 is white and made of as PP homopolymer, EP random copolymer, PB copolymer, EPB terpolymer, HDPE, LLDPE, or MDPE with TiO₂. In another variation, the second transition layer 16 is 1 to 7 microns thick. The second skin layer 18 is made of an EP impact copolymer or blend of incompatible resins such as PP homopolymer, EP copolymer, EPB terpolymer, HDPE, or LDPE copolymer, and the addition of CaCO₃, talc, and/or SiO₂. In another variation, the second skin layer 18 is 0.5 to 3.0 microns thick.

In a sixth embodiment of a five layered film 50, the first skin layer 10 and/or the first intermediate or transition layer 12 can be colored by a coloring agent that absorbs and/or scatters most of the light incident on the film. The percent light transmission of the first skin 10 and the first intermediate or transition 12 layers will be relatively low, in one embodiment from 0-70%, in another embodiment from 0-50%, and in a third embodiment from 0-30%. In the sixth embodiment the percent opacity will be relatively high, in one embodiment from 30-100%, in another embodiment from 50-100%, and in a third embodiment from 70-100%. Very little of the incident light will travel through the layer containing the color agent, reflect off the cavitated core layer, and return through the colored layer back to the observer without being scattered or absorbed. The overall percent light transmission of the film 50 is low, in one embodiment from 0-30%, in another embodiment from 0-20%; and in a third embodiment from 0-10%. The overall opacity of the film 50 is relatively high, in one embodiment from 70-100%, in a second embodiment from 80-100%, and in a third embodiment from 90-100%. This combination of low light transmission and high opacity for the film 50 without the internal reflection of light returning from the cavitated layer back to the observer provides a more restrained or sedate look, typical of a paper-like look or of a color-coated or printed film, and is a desirable packaging material which protects the packaged product from deterioration caused by exposure to light.

In a seventh embodiment of a five layered film 50, the first skin layer 10 and/or the first intermediate or transition layer 12 can be colored by a coloring agent as described in the sixth embodiment, and the second skin layer 18 and/or the second transition or intermediate layer 16 can also be colored by a coloring agent as in the first or sixth embodiment. In this embodiment, most of the light incident on the colored layer or layers having coloring agents which absorb or scatter most of the light incident upon them will be absorbed by the coloring agent. The percent light transmission of such layers will be relatively low, in one embodiment from 0-70%, in another embodiment from 0-50%, and in a third embodiment from 0-30%. The percent opacity will be relatively high, in one embodiment from 30-100%, in a second embodiment from 50-100%, and in a third embodiment from 70-100%. Very little of the incident light will travel through the layer or layers containing such a coloring agent, reflect off the cavitated core layer, and return through the colored layer back to the observer without being scattered or absorbed. The overall percent light transmission of the film 50 is low, in one embodiment from 0-30%, in another embodiment from 0-20% and in a third embodiment from 0-10%. The overall opacity of the film opacity of the film 50 is relatively high, in one embodiment from 70-100%, in another embodiment from 80-100%, and in a third embodiment from 90-100%. This combination of low light transmission and high opacity for the film 50 provides a more restrained or sedate look, typical of a paper-like look or of a color coated or printed film, on one or both sides without the internal reflection of light returning from the cavitated layer back to the observer, and can, alternatively, have the deep and vibrant look on a side selected as described in the first embodiment, and is a desirable packaging material which protects the packaged product from deterioration caused by exposure to light.

FIG. 4 is a cross sectional view of a three layered colored film 30. The film 30 is comprised of a first surface 11, a first skin layer 10, a first transition layer 12, an opaque core layer 14, and a second surface 19.

In one embodiment of a three layered film 30, the first skin layer 10 and/or the first transition layer 12 can be colored by a coloring agent. The percent light transmission of the combination of the first skin layer 10 and the first transition layer 12 is relatively high, in one embodiment from 50-99%, in another embodiment from 65-90% and in a third embodiment from 75-85%. Additionally the percent opacity of the combination of the first skin layer 10 and the first transition layer 12 is relatively low, in one embodiment from 1-50%, in another embodiment from 5-40% and in another embodiment from 10-25%. This combination of low opacity and high light transmission allows the light to enter the first surface 11 travel through the first skin layer 10 and the first transition layer 12 and reach the opaque core layer 14 from where it is reflected and travels back through the first transition layer 12 and the first skin layer 10 to reach the first surface 11 and provide for deep and vibrant color. In this embodiment, the percent light transmission of the film 30 is relatively low, in one embodiment from 0-30%, in another embodiment from 0-20% and in a third embodiment from 0-10%. Additionally the percent opacity of the film 30 is relatively high, in one embodiment from 50-100%, in another embodiment from 75-100% and in a third embodiment from 90-100%. This combination of low light transmission and high opacity for the film 30 provides a desirable packaging material which protects the packaged product from deterioration caused by exposure to light.

In one embodiment of a three layered film 30, the first skin layer 10 and/or the first transition layer 12 can be colored by a coloring agent. The percent light transmission of the combination of the first skin layer 10 and the first transition layer 12 is relatively high, in one embodiment from 50-99%, in another embodiment from 65-90% and in a third embodiment from 75-85%. Additionally the percent opacity of the combination of the first skin layer 10 and the first transition layer 12 is relatively low, in one embodiment from 1-50%, in another embodiment from 5-40% and in another embodiment from 10-25%. This combination of low opacity and high light transmission allows the light to enter the first surface 11 travel through the first skin layer 10 and the first transition layer 12 and reach the opaque core layer 14 from where it is reflected and travels back through the first transition layer 12 and the first skin layer 10 to reach the first surface 11 and provide for deep and vibrant color. In this embodiment, the percent light transmission of the film 30 is relatively low, in one embodiment from 0-30%, in another embodiment from 0-20% and in a third embodiment from 0-10%. Additionally the percent opacity of the film 30 is relatively high, in one embodiment from 50-100%, in another embodiment from 75-100% and in a third embodiment from 90-100%. This combination of low light transmission and high opacity for the film 30 provides a desirable packaging material which protects the packaged product from deterioration caused by exposure to light.

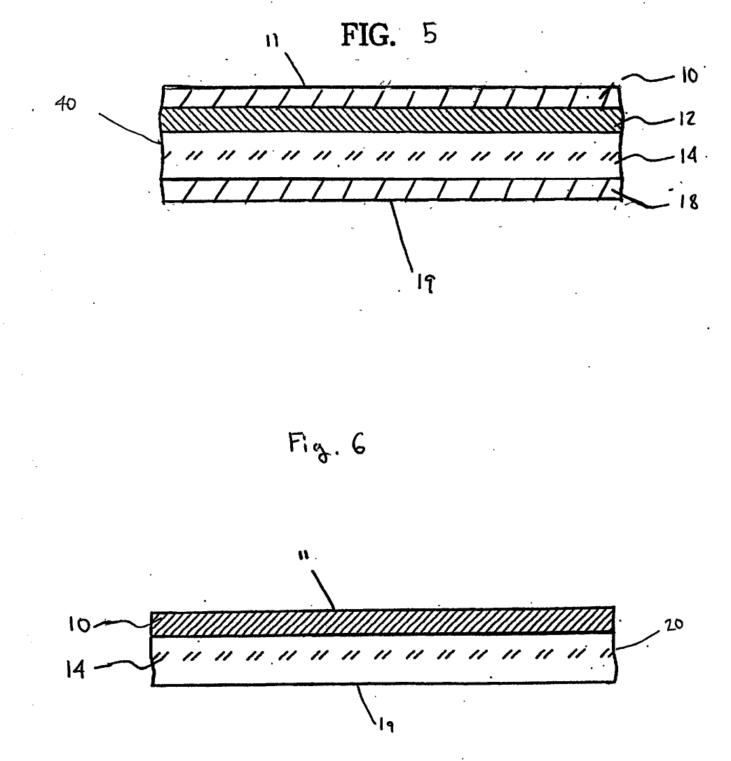

FIG. 5 is a cross sectional view of a four layered colored film 40. The film 40 is comprised of a first surface 11, a first skin layer 10, a first transition layer 12, an opaque core layer 14, a second skin layer 18, and a second surface 19.

There are multiple possible embodiments with the four layered colored film 40. The first skin layer 10, the first transition layer 12, and/or the second skin layer 18 can all be colored by a coloring agent to yield a single colored film or a dual colored film as seen on the first surface 11 and the second surface 19. Additionally, the first skin layer 10 and/or the second skin layer 18 can be printed on or treated with inorganic additives to impart a rough low-gloss paper-like feel to the first surface 11 and/or the second surface 19.

FIG. 6 is a cross sectional view of a two layered colored film 20. The film 20 is comprised of a first surface 11, a first skin layer 10, an opaque core layer 14, and a second surface 19.

There are multiple possible embodiments with the two layered colored film 20. The first skin layer 10 can be colored by a coloring agent to yield a single colored film as seen on the first surface 11 and the second surface 19. Additionally, the first skin layer 10 can be treated with inorganic additives to impart a rough low-gloss paper-like feel to the first surface 11.

In one embodiment, the opaque core layer 14 of film 50, film 30, film 40, and film 20 is a thermoplastic polymer matrix material within which is preferably located a stratum of voids. From this it is to be understood that the voids create the matrix configuration. The opacity and low light transmission of the film are preferably enhanced by the addition to the core layer 14 of at least about 1% by weight and up to about 10% by weight of void initiating on opacifying compounds, which are added to the melt mixture of the core layer 14 before extrusion. Opacifying compounds which may be used include iron oxides, carbon black, aluminum, TiO₂, and talc. Although one embodiment has a strata of voids located in the opaque core layer 14, it is possible to form an opaque core layer 14 that is substantially free of voids where the opacity is achieved by the addition of opacifying compounds.

In another embodiment, to aid in providing the film with low light transmission, especially in the UV and blue wavelengths, iron oxide is added to the core layer 14 in an amount of from about 1 to about 8% by weight, or in another embodiment about 2% to 4% by weight. Carbon black or other compounds may also be used. In another embodiment, aluminum is also added in an amount of from about 0 to about 1.0% by weight, in another embodiment from about 0.25% to about 0.75% by weight, and in another embodiment about 0.5% by weight. In another embodiment, the core layer 14 also contains from about 0.5% by weight to about 3% by weight of TiO₂ and/or talc.

In one embodiment, from about 3% to about 9% by weight of inorganic particulate material such as TiO₂ and/or talc is added to the melt mixture of the core layer 14 before extrusion.

As a result of the additions to the first skin layer 10, first transition layer 12, opaque core layer 14, second transition layer 16, and/or second skin layer 18, the film presents a differential appearance. The term “differential” as applied to the film of this invention is intended to convey the concept of the distinctly dissimilar composition and appearance of each exposed film surface: the first surface 11 and the second surface 19. When viewed from the first surface 11, the film can have vibrant coloration, a printed image that appears to float on a colored film, or a kraft paper like finish, a general color-coated or paper-like film appearance, the typical appearance of a film printed with a high opacity ink, or a more restrained or sedate looking appearance. It is contemplated that when the subject film is used in packaging, the second surface 19 is preferably positioned on the interior of a package and the first surface 11 is preferably positioned on the package exterior. When viewed from the second surface 19, the film can also have a different vibrant coloration, a different printed image that appears to float on a colored film, or a different kraft paper like finish. If the film is being used in packaging, and the second surface 19 is on the interior, then the second surface 19 can be plain white, unprinted and unfinished. But when viewed from the first surface 11, the film presents an excellent printable surface and an appealing appearance desirable for a package exterior.

When viewed from the second surface 19, the film can also have a different vibrant coloration, a different printed image that appears to float on a colored film, or a different kraft paper like finish, a general color-coated or paper-like film appearance, the typical appearance of a film printed with a high opacity ink, or a more restrained or sedate looking appearance.

The film has very high opacity and very low light transmission. A distinction is noted between opacity and light transmission for the purposes of this invention. Opacity is the opposite of transparency and is a function of the scattering and reflection of light transmitted through the film. Opacity is the ability, for example, to block out writing below it.

Through a combination of opacity resulting from cavitation of the core layer 14 and the addition of metal compounds, pigment, and inorganic particulate material, the films described in U.S. application Ser. No. 09/757,175 have high opacity, and a low light transmission in the UV range measured at 250 nm and low light transmission in the 450 nm blue range.

In one embodiment, when forming the core layer 14, as in U.S. Pat. Nos. 4,377,616; 4,632,869; 5,176,954; 5,397,635; 5,972,490; 4,758,396; 4,758,462; 4,652,489; 4,741,950; 4,594,211; and 6,004,664 the disclosures of which are incorporated herein by reference in their entirety, a master batch technique can be employed by either forming the void initiating particles in situ or in adding preformed spheres to a molten thermoplastic matrix material. After the formation of a master batch, appropriate dilution of the system can be made by adding additional thermoplastic matrix material until the desired proportions are obtained. However, the components may also be directly mixed and extruded instead of utilizing a master batch method.

The void-initiating particles which are added as filler to the polymer matrix material of the core layer 14 can be any suitable organic or inorganic material which is incompatible with the core material at the temperature of biaxial orientation such as polybutylene terephthalate, nylon, solid or hollow preformed glass spheres, metal beads or spheres, ceramic spheres, calcium carbonate, COC's (cyclic olefin polymers and cyclic olefin copolymers), etc. COC's are described in U.S. Pat. No. 6,048,608 issued to Peet, et al; this patent is incorporated herein by reference in its entirety.

The polyolefin contemplated as the material in the core layer 14 includes polypropylene, polyethylene, polybutene and copolymers and blends thereof. One embodiment uses an isotactic polypropylene containing at least about 80% by weight of isotactic polypropylene, wherein it is preferred that the polypropylene have a melt flow index of from about 2 to 10 g/10 min. Another embodiment uses a high density polyethylene, with a density of 0.95 or greater.

In one embodiment, the average diameter of the void-initiating particles is from about 0.1 to about 10 microns. These particles may be of any desired shape although it is preferred that they be substantially spherical in shape. This does not mean that every void is the same size. It means that, generally speaking, each void tends to be of like shape when like particles are used even though they vary in dimensions. These voids may assume a shape defined by two opposed and edge contacting concave disks.

In one embodiment, characteristics of opacity and appearance are obtained when the two average major void dimensions are greater than about 30 microns.

In another embodiment, the void-initiating particle material, is incompatible with the core material, at least at the temperature of biaxial orientation.

The core layer 14 has been described above as being a thermoplastic polymer matrix material within which is located a stratum of voids. From this it is to be understood that the voids create the matrix configuration. The term “stratum” is intended to convey the understanding that there are many voids creating the matrix. In one embodiment, the voids themselves are oriented so that the two major dimensions are aligned in correspondence with the direction of orientation of the polymeric film structure. After each void has been formed through the initiation of the described particle, the particle generally contributes little else to the system. This is because its refractive index can be close enough to the matrix material that it makes no contribution to opacity. When this is the case, the opacity is principally a function of the light scattering effect which occurs because of the existence of the voids in the system. In another embodiment, iron oxide in an amount of from about 1 to about 8% by wt.; in another embodiment from about 2% to 4% ; and in one embodiment aluminum in an amount from about 0 to about 1.0% by wt., in another embodiment from about 0.25% to 0.75% are added to the core matrix. Carbon black or other compounds may also be used in lieu of some or all of the iron oxide.

A typical void of the core is defined as having major dimensions X and Y and minor dimension Z, where dimension X is aligned with machine direction orientation, dimension Y is aligned with transverse direction orientation and dimension Z approximately corresponds to the cross-sectional dimension of the spherical particle which initiated the void.

In one embodiment, the orientation conditions are such that the X and Y dimensions of the voids of the core are major dimensions in comparison to the Z dimension. Thus, while the Z dimension generally approximates the cross-sectional dimension of the spherical particle initiating the void, X and Y dimensions are significantly greater. By way of illustration, room temperature biaxial orientation of a polypropylene matrix containing polybutylene terephthalate (PBT) spheres of the size and amount contemplated herein, would not be effective for this embodiment. Either void splitting would occur, or, voids of insignificant size would result. Polypropylene should be oriented at a temperature significantly higher than its glass transition temperature. The temperature conditions will permit X and Y to be at least several multiples of the Z dimension without void splitting at least to any significant degree. When this is accomplished, optimum physical characteristics, including low water vapor transmission rates and a high degree of light scattering are obtained without void splitting or film fibrillating.

As indicated above, the matrix polymer and the void initiating particle must be incompatible and this term is used in the sense that the materials are two distinct phases. The spherical void initiating particles constitute a dispersed phase throughout the lower melting polymer which polymer will, ultimately, upon orientation, become a void-filled matrix with the spherical particles positioned somewhere in the voids.

As a result of the biaxial orientation of the film structure herein, in addition to opacifying the core layer 14 of the structure, the orientation improves other physical properties of the composite layers such as flex-crack resistance, Elmendorff tear strength, elongation, tensile strength, impact strength and cold strength properties. The resulting film can have, in addition to a rich high quality appearance and excellent opacifying characteristics, low water vapor transmission rate characteristics and low oxygen transmission rate characteristics. This makes the film ideally suited for packaging food products including liquids. The film also has attractive utility as a decorative wrap material.

It is believed that because of comparative sphericity of the void-initiating particles, the voids are closed cells. This means that there is virtually no path open from one side of the core to the other through which liquid or gas can transverse.

The polymers contemplated herein for the first skin layer 10, first transition layer 12, second transition layer 16, and second skin layer 18 can be selected from those polymers typically employed in the manufacture of multi-layered films.

Examples of materials which are suitable for use as the skin layers are coextrudable materials which form a seal upon application of elevated temperatures and, at least slight pressure. Examples of polymeric materials which can be used for the sealing layer include olefinic homo-, co- or terpolymers. The olefinic monomers can comprise 2 to 8 carbon atoms. Specific examples include polypropylene, ethylene-propylene random copolymer, ethylene-butene-1 copolymer, ethylene-propylene-butene-1 terpolymer, propylene-butene copolymer, high density polyethylene, low density polyethylene, linear low density polyethylene, very low density polyethylene, metallocene-catalyzed polyethylene, metallocene-catalyzed polymers known by the term plastomer, metallocene-catalyzed ethylene-hexene copolymer, metallocene-catalyzed ethylene-butene copolymer, metallocene-catalyzed ethylene-octene copolymer, ethylene-methacrylic acid copolymer, ethylene-vinyl acetate copolymer and ionomer resin. A blend of the foregoing materials is also contemplated such as a blend of the plastomer and ethylene-butene copolymer.

The core and transition layers of the present invention may be any one of the coextrudable, biaxially orientable film-forming resins known in the art. Such materials include, but are not limited to, isotactic polypropylene high density polyethylene, low density polyethylene, linear low density polyethylene, very low density polyethylene, metallocene-catalyzed polyethylene and polypropylene, metallocene-catalyzed polymers known by the terplastomer syndiotactic polypropylene, propylene copolymers and terpolymers which include other monomers such as ethylene and/or butene-1, ethylene copolymers and terpolymers which include other monomers such as propylene and/or butene-1. Typical copolymers are ethylene-propylene copolymers, ethylene-butene-1 copolymers, butene-1-propylene random copolymers, and ethylene-propylene block copolymers. Typical terpolymers are ethylene-propylene-butene-1 terpolymers. Alternative and useful thermoplastic materials include, but are not limited to nylon, polyester, ethylene-vinyl acetate copolymer, and ethylene-vinyl alcohol copolymer. Blends of any of the foregoing homopolymers, copolymers and terpolymers are contemplated.

Ethylene-propylene-butene-1 random terpolymers appropriate for use in the core layer include those containing 1-5 weight percent random ethylene and 10-25 weight percent random butene-1, with the balance being made up of propylene. The amounts of the random ethylene and butene-1 components in these terpolymers may be in the range of 10 to 25 weight percent (ethylene plus butene-1) based on the total amount of the copolymer.

The copolymers and terpolymers may have a melt flow rate in the range of about 1.5 to 15 g/10 min, with a density of about 0.9 and a melting point in the range of about 115 to about 170° C.

In one embodiment, the exposed first surface 11 and/or second surface 19 are treated in a known and conventional manner, e.g., by any one of corona discharge, flame, and plasma treatment, to improve its receptivity to inks and/or its suitability for such subsequent manufacturing operations as lamination.

In one embodiment, the exposed treated or untreated first surface 11 and/or second surface 19 have applied to it, coating compositions or substrates such as another polymer film or laminate; a metal foil such as aluminum foil; cellulosic webs, e.g. numerous varieties of paper such as corrugated paperboard, craft paper, glassine, cartonboard; non-woven tissue, e.g., spunbonded polyolefin fiber, melt-blown microfibers, etc. The application may employ a suitable adhesive, e.g., a hot melt adhesive such as low density polyethylene, ethylene-methacrylate copolymer, water-based adhesive such as polyvinylidene chloride latex, and the like.

The film of the present invention may be laminated to another polyolefin film (e.g., thermal, adhesive, extrusion, etc).

In one embodiment, the first skin layer 10, first transition layer 12, second transition layer 16, and second skin layer 18 includes up to about 90% by wt., in another embodiment from about 2% to about 20% by wt., and in a third embodiment from about 3% to about 10% by wt. of a coloring agent is used. U.S. Pat. Nos. 5,894,048; 4,894,264; 4,536,184; 5,683,805; 5,328,743; and 4,681,803 disclose the use of coloring agents, the disclosures of which are incorporated herein by reference in their entirety. Suitable coloring agents include pigments and dyes. In one embodiment, pigments and dyes include organic pigments and dyes such as phthalocyanine, azo, condensed azo, azo lake, anthraquinone, perylene/perinone, indigo/thioindigo, isoindolinone, azomethineazo, dioxazine, quinacridone, aniline black, triphenylmethane and carbon black pigments; and inorganic pigments and dyes such as titanium oxide, iron oxide, iron hydroxide, chrome oxide, spinel-form calcination type, chromic acid, chrome vermilion, iron blue, aluminum powder and bronze powder pigments. These pigments may be provided in any form or may be subjected in advance to various dispersion treatment in a manner known per se in the art. Depending on the material to be colored, the coloring agent can be added with one or more of various additives such as organic solvents, film-forming resins (in not a large proportion), flame retardants, antioxidants, ultraviolet absorbers, plasticizers and surfactants. Colored compounded thermoplastics which are commercially available are easier to use, although direct addition of a dye or pigment to the extrusion is possible. In another embodiment colored compounded thermoplastic concentrates are used. (For example from Schulman: Polybatch Blue P4021, Polybatch Blue P4535, Polybatch Red P50346, Polybatch Yellow P2214F, Polybatch Green P3510F, Polybatch Brown P1028F, and Polybatch Orange P10307; from Ampacet: LR-92396 (blue), LR-92011 (blue), LR-92397 (green), LR-92398 (yellow), and LR-92010 (red); from Milliken Clear Tint Blue 9805, Clear Tint Red 9803, Clear Tint Amber 9808, and Clear Tint Green 9807.) In a third embodiment colored compounded thermoplastic concentrates contain lower amounts of titanium dioxide or are otherwise lower in opacity. Furthermore, a color on the first surface 11 or second surface 19 of the film allows printing of laminated or unlaminated structures without requiring a base colored ink.

The first skin layer 10 and/or the second skin layer 18 may be heat sealable or non heat sealable. In one embodiment, if the second skin layer 18 is not heat sealable, then a heat sealable layer (not shown) may be applied to the second skin layer 18. A heat sealable layer (not shown) may be, for example, vinylidene chloride polymer or an acrylic polymer; or heat sealable layer (not shown) may be coextruded from any of the heat sealable materials described for the first skin layer 10 and/or the second skin layer 18. Vinylidene chloride polymer or acrylic polymer coating may also be applied to the exposed first surface 11 or the second surface 19.

In another embodiment, if the first skin layer 10 and/or the second skin layer 18 are heat sealable, it can be fabricated from any of the heat sealable copolymers, blends of homopolymers and blends of copolymer(s) and homopolymer(s) heretofore employed for this purpose. Illustrative of heat sealable copolymers which can be used for the first skin layer 10 and/or the second skin layer 18 of the present film are ethylene-propylene copolymers containing from about 1.5 to about 12, and alternatively from about 3 to about 7, weight percent ethylene, and ethylene-propylene-butene terpolymers containing from about 1 to about 10, and alternatively from about 1 to about 6 weight percent ethylene and from about 70 to about 97 weight percent propylene. In another embodiment, heat sealable blends of homopolymer can be utilized for the first skin layer 10 and/or the second skin layer 18 which include from about 1 to about 99 weight percent polypropylene homopolymer, e.g., one which is the same as, or different from, the polypropylene homopolymer constituting core layer 14 blended with from about 99 to about 1 weight percent of a linear low density polyethylene (LDPE). If the first skin layer 10 and/or the second skin layer 18 are heat-sealable, corona, flame, or plasma treatment of that layer is optional.

In another embodiment, heat sealable blends of copolymer(s) and homopolymer(s) which may be used for the first skin layer 10 and/or the second skin layer 18 include: a blend of from about 5 to about 19 weight percent of polybutylene and from about 95 to about 81 weight percent of a copolymer of propylene (80 to about 95 mole percent) and butylene (20 to about 5 mole percent); a blend of from about 10 to about 90 weight percent of polybutylene and from about 90 to about 10 weight percent of a copolymer of ethylene (2 to about 49 mole percent) and a higher olefin having 4 or more carbon atoms (98 to about 51 mole percent); a blend of from about 10 to about 90 weight percent polybutylene and from about 90 to about 10 weight percent of a copolymer of ethylene (10 to about 97 mole percent) and propylene (90 to about 3 mole percent); and, a blend of from about 90 to about 10 weight percent of polybutylene, and from about 10 to about 90 weight percent of a copolymer of propylene (2 to about 79 mole percent) and butylene (98 to about 21 mole percent).

In one embodiment, the first skin layer 10, first transition layer 12, core layer 14, second transition layer 16, and second skin layer 18 are coextruded. Thereafter, the film is preferably biaxially oriented. For example, when employing polypropylene for the core matrix and the skin layers and employing PBT as the void initiating particles, a machine direction orientation is preferably from about 4 to about 8 and a transverse orientation is preferably from 4 to about 10 times at a drawing temperature of about 100° C. to 170° C. to yield a biaxially oriented film. A preferred film thickness is from about 0.5 mil to about 3.5 mils.

Although various embodiments have been disclosed for the five layer film 50, three layer film 30, four layer film 40, and two layer film 20, additional embodiments of films with two or more layers are possible by interchanging elements of coloring agents, printing, and inorganic and organic additives that would be clear to one with ordinary skill in the art.

In another embodiment the first skin layer 10 and/or the second skin layer 18 has a coating or metal layer applied. U.S. Pat. Nos. 6,077,602; 6,013,353; 5,981,079; 5,972,496; 6,074,762; 6,025,059; and 5,888,648 disclose the use of coatings and/or metal layers on a film, and are disclosed herein by reference. In one embodiment, suitable coatings may include PVdC's or acrylics which serve to boost gloss, enhance machineability, and/or enhance ink adhesion; suitable metals may include aluminum.

Examples 1-6, which follow, describe films which may provide suitable substrates for digital printing.

### EXAMPLE 1

Samples were produced having the following structure:

Corona Treatment

| | |
|---|---|
| L1 | EP impact copolymer |
| L2 | Homopolymer PP or Terpolymer with color concentrate |
| L3 | Homopolymer core (+cavitating agent) |
| L4 | Homopolymer PP or Terpolymer with opacifier |
| L5 | EP impact copolymer |
| | Corona Treatment |

Thickness of the uncavitated film was 0.80 mils.

The following materials were run using this structure:

| | | Skin | | | | |
|---|---|---|---|---|---|---|
| | | L1 | | | | |
| | | and | | | | |
| | | L5 | | L4 | | L2 |
| | L1 and L5 | thick | | thick | | thick |
| Run | Resin | (ga) | Layer 4 resin | (ga) | Layer 2 resin | (ga) |
| 1 | Montell 8523 | 0.5 | Fina 3371 w/40% | 8 ga | Fina 3371 w/30% | 4 ga |
| | | | Schulman CTW5050 | | Schulman | |
| | | | | | P10204/5 | |
| 2 | Montell 8523 | 0.5 | Chisso XPM7880 | 8 ga | Chisso XPM7800 | 4 ga |
| | | | w/40% Schulman | | w/30% Schulman | |
| | | | P8555-SC | | P10204/5 | |

Before producing sample 3 and 4 - add 8% Ticona Celenex 1300A PBT to the core

| | | | | | | |
|---|---|---|---|---|---|---|
| 3 | Montell 8523 | 0.5 | Chisso XPM7880 | 8 ga | Chisso XPM7800 | 4 ga |
| | | | w/40% Schulman | | w/30% Schulman | |
| | | | P8555-SC | | P10204/5 | |
| 4 | Montell 8523 | 0.5 | Fina 3371 w/40% | 8 ga | Fina 3371 w/30% | 4 ga |
| | | | Schulman CTW5050 | | Schulman | |
| | | | | | P10204/5 | |

Material Descriptions:
Montell 8523 is an EP impact copolymer
Schulman P8555-SC (50% TiO2 in EP random copolymer (Fina 8573))
Schulman CTW5050 referred above is 50% TiO2 (Millenium RCL4) in PP homopolymer
Schulman P10204/5 is a brown masterbatch containing a total of 35%
pigment (iron oxide, carbon black, TiO2) in PP homopolymer.
Chisso XPM7880 is an EPB terpolymer
Fina 3371 is a 3 MF PP homopolymer

The films produced during the experiment had the brown and white kraft paper type of color and fiber-like appearance to them.

### EXAMPLE 2

A second set of runs was made having the following structure:

Corona Treatment

| | |
|---|---|
| L1 | Propylene or ethylene copolymers + additives |
| L2 | Homopolymer with color concentrate |
| L3 | Homopolymer core + cavitating agent |
| L4 | Homopolymer with opacifier |
| L5 | Propylene or ethylene copolymers + additives |
| | Corona Treatment |

The core homopolymer was cavitated in all cases.

| | | Skin | | | | |
|---|---|---|---|---|---|---|
| | | L1 | | | | |
| | | and | | | | |
| | Skin Resin | L5 | | L4 | | L2 |
| | (L1 & L5 | thick | | thick | | thick |
| Run | layers) | (ga) | Layer 4 resin | (ga) | Layer 2 resin | (ga) |
| 5 | Montell 8523 + | 6 ga | Chisso XPM7880 | 8 ga | Chisso XPM | 5-8 ga |
| | 16% | | w/40% Schulman | | 7800 w/30% | |
| | Schulman | | CTW5050 | | Schulman | |
| | T4448/50 | | | | P10204/5 | |
| 6 | Montell 8523 | 1 ga | Chisso XPM7880 + | 8 ga | Chisso XPM7880 + | 5 ga |
| | | | 20% T4448/5 + 40% | | 20% T4448/5 + | |
| | | | CTW5050 | | 30% P10204/5 | |

Material Description:
Schulman Papermatch T4448/50 (HW HDPE w/high CaCO3 loading and TiO2)

Properties of the films produced in Examples 1 and 2 are given in Table 1.

TABLE 1

| | | | Optical | | Treatment | | | | | |
|---|---|---|---|---|---|---|---|---|---|---|
| Sample | Skins | Core | Gauge | Yield | Both sides | | Gloss | Gloss | COF | COF |
| | | | | | | | Brown | White | Brown | |
| | | | | | | Haze (%) | side | side | side | white side |
| 1 | Brown/white | Clear | 75.6 | 40400 | 38 | 49.4 | 30.7 | 33.4 | 0.421 | 0.430 |
| 2 | Brown/white | Clear | 80.9 | 37800 | 37 | 48.6 | 33.5 | 34.5 | 0.671 | 0.765 |
| 3 | Brown/white | Cavitated | 110.7 | 37200 | 36 | 29.2 | 35.9 | 36.4 | 0.619 | 0.765 |
| 4 | Brown/white | Cavitated | 109 | 38200 | 37 | 27.1 | 30.8 | 36.6 | 0.421 | 0.430 |
| | | | | | | Light | | | | |
| | | | | | | Trans % | | | | |
| 5 | White matte/ | PP | 99 | 37177 | 39 | 31 | 13.4 | 15.1 | 0.28 | 0.27 |
| | tan matte | (cavitated) | | | | | | | | |
| | (uniform | | | | | | | | | |
| | surface look) | | | | | | | | | |
| 6 | White matte/ | PP | 96 | 38845 | 37 | 30.4 | 28.1 | 25.3 | 0.32 | 0.33 |
| | tan matte | Cavitated | | | | | | | | |
| | (fiber-like | | | | | | | | | |
| | surface look) | | | | | | | | | |

| | | |
|---|---|---|
| Brown kraft paper bag | 5.1 | |
| White bleached paper | | 5 |
| bag | | |

100 optical gauge units = 1 mil = 25.4 μm
Yield is given in in²/lb (35,500 in²/lb = 50.4 m²/kg)
Treatment is given in dyne/cm
Both gloss and COF are unitless
The test procedures were as follows:
for yield - ASTM D4321 (ExxonMobil 520);
for treatment - ASTM D5946 (ExxonMobil 417);
for haze - ASTM D1003 (ExxonMobil 444);
for gloss - ASTM D2457 (ExxonMobil 442);
for COF - ASTM D1894 (ExxonMobil 428); and
for light transmission - ASTM D1003 (ExxonMobil 456).

The films of Example 2, produced during the second experiment had the brown and white paper type of color and also lower gloss and a rougher surface finish to more closely resemble the look and texture of kraft paper. Sample 5 had a uniform type of surface appearance, whereas Sample 6 was produced with a non-uniform “fiber-like” surface appearance that more closely resembles the “fiber-like” look of kraft paper. All these films are surface printable on either the white kraft or brown kraft side. The side opposite the print side is also surface treated and hence suitable for either adhesive or extrusion lamination to a high barrier clear or high barrier metallized film.

### EXAMPLE 3

A third set of samples was produced to evaluate color concentrates for potential use in flex-pack applications, using the following structure:

| | | | |
|---|---|---|---|
| L1 | 3 | ga. | Dow Dowlex 2027A MDPE |
| L2 | 14 or 27 | ga. | Exxon 4612 Homopolymer PP + color concentrate (see |
| | | | Table 2) |
| L3 | 40 or 53 | ga. | Exxon 4612 Homopolymer PP + Celanese 1300A |
| | | | cavitating agent |
| L4 | 27 | ga. | Exxon 4612 Homopolymer PP |
| L5 | 3 | ga. | Exxon 4612 Homopolymer PP |
| | | | Corona Treatment |

The films had a thickness of ±1.4 mils when cavitated, and a polymer thickness equivalent to ±1.0 mils if no cavitation had occurred. The core layer thickness, L3, shown above is based on the thickness that would be obtained if the film were not cavitated. The color concentrates were run at a 2:1 let down ratio.

Color concentrates used, colored layer thicknesses, color measurements, using a HunterLab UltraScan XE, and gloss measurements are summarized in Table 2 and Table 3.

TABLE 2

| | L2 | L3 | | | | | |
|---|---|---|---|---|---|---|---|
| Sample | Thickness | Thickness | Color mater batch used in L2 | a* | b* | L* | Opacity |
| 7 | 27 ga. | 40 ga. | Ampacet LR-92010 (flex-pack red) | 46.79 | −8.39 | 56.04 | 67.76 |
| 8 | 14 ga. | 53 ga. | Ampacet LR-92010 (flex-pack red) | 44.48 | −9.73 | 59.69 | 70.80 |
| 9 | 27 ga. | 40 ga. | Ampacet LR-92011 (flex-pack blue) | −17.12 | −40.60 | 46.13 | 66.38 |
| 10 | 14 ga. | 53 ga. | Ampacet LR-92011 (flex-pack blue) | −24.70 | −40.51 | 54.52 | 73.37 |

TABLE 3

| | | | Gloss at Different | | | |
|---|---|---|---|---|---|---|
| | | | Angles of Incident Light | | | |
| Sample | Film Type | Color | 20° | 45° | 60° | 85° |
| 7 | Cavitated White | Dark Red | 43.1 | 63.0 | 87.4 | 97.6 |
| 8 | Cavitated White | Light Red | 39.9 | 68.4 | 88.8 | 97.2 |
| 9 | Cavitated White | Dark Blue | 44.1 | 53.9 | 85.2 | 97.9 |
| 10 | Cavitated White | Light Blue | 38.2 | 54.5 | 83.1 | 97.3 |
| Reference | Non-cavitated White | Solid | 33.0 | 30.0 | 51.4 | 93.7 |
| | | White | | | | |
| Reference | Clear | No color | 104.8 | 85.3 | 130.4 | 104.2 |

[image]

Gloss is a ratio of incident light to reflected light. The data shows that the gloss is higher for the cavitated colored samples versus the non-cavitated white sample (solid white sample) at all angles of incident light. The design of the cavitated colored samples allows more light to be reflected back to the observer than a non-cavitated white film. The incident light is scattered by the white pigment in the non-cavitated white film, which results in less reflected light and a lower gloss value. However, more incident light is reflected by the cavitated colored film, which results in a higher gloss value.

### EXAMPLE 4

A fourth set of runs was made having the following structure:

| | |
|---|---|
| L1 | 3 ga. terpolymer sealant |
| L2 | ±20 ga. homopolymer (+color concentrate) |
| L3 | ±54 ga. homopolymer + 6% cavitating agent |
| L4 | 20 ga. homopolymer (+opacifier) |
| L5 | 3 ga. terpolymer sealant |

The colorant was located in a relatively thin tie layer sandwiched between a clear skin and a white, cavitated core. In some cases, the thickness of L2 was doubled. In some other cases, L2 was made half as thick. To maintain a constant film thickness, the difference in thickness was made up by changing the core thickness to compensate for the thicker or thinner L2.

| | | | | | | | | | L2 |
|---|---|---|---|---|---|---|---|---|---|
| | % Loading | | | | | | | | Thickness |
| Schulman | | | | | | | | | |
| Polybatch | | | 10 | | | 25 | | | Normal |
| Blue P4021 | | | 10 | | | | | | ½X |
| | | | | | | | | | normal |
| | | | 10 | | | | | | 2X normal |
| Polybatch | 5 | 8 | | 15 | | 25 | | | Normal |
| Red P50346 | | | | | | | | | |
| Polybatch | 5 | | 10 | | 22 | | | | normal |
| Yellow P2214F | | | | | | | | | |
| Polybatch | 5 | | 10 | | | 25 | 50 | 75 | Normal |
| Green 3510F | | | | | | | | | |
| Polybatch | 5 | | 10 | | | 25 | 50 | 75 | Normal |
| Brown P1028F | | | | | | | | | |
| Ampacet | | | | | | | | | |
| LR-92396 (blue) | | | 10 | | | 25 | 50 | 75 | Normal |
| LR-92397 (green) | | | 10 | | | 25 | 50 | 75 | Normal |
| LR-92398 (yellow) | | | | | 21 | | 50 | 75 | Normal |

The a*, b* and L* values for all of these films have been measured along with all their light transmission and gloss values. The data are given in Table 3.

TABLE 3

| | L2 layer | | | | | |
|---|---|---|---|---|---|---|
| | gauge | a* | b* | L* | Gloss | LT |
| 10% Polybatch Blue P4021/90% 4612E2 | Normal | −14.51 | −24.89 | 78.03 | 67 | 27.2 |
| 10% Polybatch Blue P4021/90% 4612E2 | 0.5X normal | −7.61 | −12.34 | 87.32 | 71.5 | 29.6 |
| 10% Polybatch Blue P4021/90% 4612E2 | 2X normal | −17.91 | −32.67 | 71.48 | 65.4 | 25.3 |
| 25% Polybatch Blue P4021/90% 4612E2 | Normal | −17.07 | −39.64 | 63.68 | 48.9 | 18.5 |
| 5% Polybatch Red P50346/95% Exxon 4612E2 | Normal | 23.56 | 6.84 | 68.81 | 72.6 | 26 |
| 8% Polybatch Red P50346/92% Exxon 4612E2 | Normal | 33.78 | 11.93 | 61.87 | 63.4 | 21.4 |
| 15% Polybatch Red P50346/85% Exxon 4612E2 | Normal | 44.65 | 51.52 | 53.36 | 51 | 13.4 |
| 25% Polybatch Red P50346/75% Exxon 4612E2 | Normal | 47.49 | 27.47 | 49.01 | 41.8 | 6.8 |
| 5% Polybatch Yellow P2214F/95% Exxon 4612E2 | Normal | −3.3 | 22.52 | 83.72 | 78.3 | 33.9 |
| 10% Polybatch Yellow P2214F/90% Exxon 4612E2 | Normal | −0.27 | 0.69 | 86.47 | 68.1 | 31 |
| 22% Polybatch Yellow P2214F/78% Exxon 4612E2 | Normal | 0.28 | 60.33 | 82.63 | 54 | 25 |
| 5% Polybatch Green P3510F/95% Exxon 4612E2 | Normal | −13.19 | 14.83 | 82.2 | 79.3 | 27.5 |
| 10% Polybatch Green P3510F/90% Exxon 4612E2 | Normal | −20.48 | 22.8 | 77.22 | 69 | 28 |
| 25% Polybatch Green P3510F/75% Exxon 4612E2 | Normal | −33.32 | 34.53 | 66.46 | 45.5 | 18.6 |
| 50% Polybatch Green P3510F/50% Exxon 4612E2 | Normal | −35.4 | 31.82 | 59.07 | 31.6 | 12.6 |
| 75% Polybatch Green P3510F/25% Exxon 4612E2 | Normal | −32.77 | 27.03 | 54.91 | 15 | 7.3 |
| 5% Polybatch Brown P1028F/95% Exxon 4612E2 | Normal | 4.93 | 8.08 | 67.3 | 66 | 22.4 |
| 10% Polybatch Brown P1028F/90% Exxon 4612E2 | Normal | 8.06 | 11.02 | 54.19 | 52.8 | 15.1 |
| 25% Polybatch Brown P1028F/75% Exxon 4612E2 | Normal | 6.83 | 7.37 | 35.96 | 35.5 | 3.9 |
| 50% Polybatch Brown P1028F/50% Exxon 4612E2 | Normal | 5.5 | 5.98 | 33.28 | 26 | 0.2 |
| 75% Polybatch Brown P1028F/25% Exxon 4612E2 | Normal | 5.27 | 5.41 | 31.88 | 23.4 | 0 |
| 10% LR-92396 (blue)/90% Exxon 4612E2 | Normal | −33.83 | −28.49 | 75.83 | 64.8 | 24.3 |
| 25% LR-92396 (blue)/75% Exxon 4612E2 | Normal | −38.62 | −40.05 | 64.69 | 58.6 | 23.6 |
| 50% LR-92396 (blue)/50% Exxon 4612E2 | Normal | −32.18 | −44.93 | 57.05 | 46.6 | 9.5 |
| 75% LR-92396 (blue)/25% Exxon 4612E2 | Normal | −27.39 | −45.34 | 52.96 | 40.2 | 7.7 |
| 10% LR-92397 (green)/90% Exxon 4612E2 | Normal | −24.49 | −1.21 | 87.92 | 80.6 | 28.9 |
| 25% LR-92397 (green)/75% Exxon 4612E2 | Normal | −42.73 | 0.22 | 82.27 | 68.5 | 25.9 |
| 50% LR-92397 (green)/50% Exxon 4612E2 | Normal | −58.37 | 3.74 | 76.72 | 59.5 | 22.4 |
| 75% LR-92397 (green)/25% Exxon 4612E2 | Normal | −66.93 | 7.18 | 72.55 | 46.8 | 21.4 |
| 21% LR-92398 (yellow)/79% Exxon 4612E2 | Normal | −9 | 40.35 | 93.18 | 89.7 | 31.7 |
| 50% LR-92398 (yellow)/50% Exxon 4612E2 | Normal | −9.93 | 67.02 | 91.65 | 75.2 | 29.7 |
| 75% LR-92398 (yellow)/25% Exxon 4612E2 | Normal | −8.32* | 80.86* | 90.59* | 61.5* | 29.8* |
| 10% Polybatch Blue P4021/90% 4612 E2 + | Normal | −0.39 | −14.55 | 65.12 | 44.9 | 12.4 |
| 10% Polybatch Red P50346/90% 4612E2 | Normal | 44.75 | 21.9 | 49.02 | 52.5* | |

For the last entry in Table 3, a blue colorant was coextruded in L2 with a red colorant in L4. There was very little influence of the color on either side affecting the color on the other side.

Those films that were made in such a manner that much of the incident light on the film surface passed into the film, reflected off the cavitated core surface, and passed back through the entry surface had a very vibrant, deep appearing look to them. Many of the films that have been produced have a more “vibrant” appearance than do some of the others. The color concentrates that contain lower amounts of titanium dioxide or are otherwise lower in opacity correlate to this aesthetic preference.

### EXAMPLE 5

In a fifth experimental run, L2 of Example 4 was set up to consist of two separate coextruded layers. Red color concentrate was fed into one layer and blue was fed into the other. A purple color was produced.

### EXAMPLE 6

In a sixth experimental run, the following film structure was set up:

Corona Treatment

| | | |
|---|---|---|
| L1 | 10 ga. | MDPE (+color concentrate) |
| L2 | 112 ga. | HDPE + CaCO₃ |
| L3 | 8 ga. | MDPE |
| | | Corona Treatment |

A yellow color concentrate, Polybatch Yellow P20287, purchased from A. Schulman Inc., was introduced into the L1 layer at 10%. An aesthetically pleasing film, yellow on one side and white on the other was obtained.

### Digital Pinting Techniques

In digital printing, a printing device, which responds to digital signals, is operatively connected to a source for generating digital signals, such as a computer. The source for generating digital signals may include a device, such as a scanner, for converting a visual image into an electronic image. Electronic images may also be generated by other devices, such as key board devices. The electronic images may be stored in the source for generating digital signals as digital data.

The digital signals may be transmitted from the source to the printing device, electronically, e.g., in the form of a square wave pulse, where the digital signal is either “1” (e.g., for “on”) or “0” (e.g., for “off”). An example of a digital printing technique is described in U.S. Pat. No. 6,312,078.

In connection with applying indicia to film surfaces, digital printing techniques provide advantages over other printing techniques, involving gravure, flexo or offset printing. In digital printing, a separate physical printing media need not be prepared for each image transferred to the film surface, especially when the image is changed. Digital printing is particularly suited for both (1) continuous applications of multiple indicia to film fed in the form of continuous webs, and (2) batch applications restricted to sheet fed operations. Other techniques tend to be more suited to one or the other of these operations. For example, gravure and flexo printing techniques tend to be more suited to the above-mentioned web fed operations, whereas offset printing techniques tend to be restricted to sheet fed operations.

The printing device responsive to digital signals may apply indicia to the surface of a film in a variety of manners, including electrostatic printing, thermal transfer printing and ink jet printing.

U.S. Pat. No. 5,789,123 describes the printing of film surfaces by electrostatic printing, particularly electrostatic printing involving the use of a liquid toner, especially an Indigo type liquid toner.

U.S. Pat. No. 5,891,552 describes the printing of film surfaces by thermal transfer printing.

U.S. Pat. Nos. 6,310,115 and 6,315,405 describe ink jet printing. Digital printing with an ink jet printer is particularly described in U.S. Pat. No. 6,315,405. The application of a radiation curable ink by ink jet to a surface and the subsequent radiation curing of the ink is described in U.S. Pat. No. 6,310,155.

In order to better adapt a film surface to accept indicia from a printer, various treatments and/or coatings may be applied to the film surface. Such treatments and/or coatings include (1) treatments which increase the surface tension of the film surface, such as corona, plasma and flame treatments, (2) the application of primers, such as polyethyleneimine and epoxy resins, and (3) the application of print enhancing coatings, such as acrylic binders, optionally including inorganic fillers, such as silica or calcium carbonate.

In preparing a film surface for thermal transfer printing, all three of the above-mentioned treatments and coatings may be utilized, as discussed in U.S. Pat. No. 5,891,522. For example, the film surface may be first treated to create a high energy surface environment sufficient for the adhesion of a primer and print enhancing coating. Such treatments include flame, corona, or plasma treatment or other methods which can oxidize the film surfaces. Corona treatment is accomplished by exposing the film surface to a high voltage corona discharge while passing the film between spaced electrodes.

A primer enhances binding of the print enhancing coating to the uncoated film. Typical primers are polymers, such as polyethyleneimine and epoxy resins, with good adhesion to the uncoated films.

The print enhancing coating may comprise a binder, such as an acrylic binder, with optional additives, such as particulate materials, surfactants, agents which improve the coefficient of friction, agents which provide antiblocking properties, wetting agents, crosslinking agents, stabilizers, catalysts, plasticizers, defoamers, slip agents, anti-static agents and antioxidants. Specific examples of modifiers disclosed in U.S. Pat. No. 5,891,552 include natural waxes such as paraffin wax, microcrystalline wax, beeswax, camauba wax, montan wax (lignite wax), etc. and synthetic waxes such as hydrogenated castor oil, chlorinated hydrocarbon waxes, long chain fatty acid amides and the like.

Acrylic polymer binders are well known in the art and are described in U.S. Pat. Nos. 3,753,769; 4,058,645 and 4,749,616. The print enhancing coating may also comprise epoxy polymers, such as those described in U.S. Pat. No. 6,025,059.

The acrylic binder may comprise a thermoplastic polymer or copolymer of a carboxylic acid containing vinylic unsaturation such as acrylic acid or methacrylic acid or ester of those acids. The acrylates may contain lower alkyl groups such as those ranging from about 1 to about 16 carbon atoms, specific examples include methyl, ethyl, butyl, lauryl and stearyl. Useful acrylic resins may be modified with non-acrylic monomers such as acrylonitrile, butadiene and/or styrene.

As pointed out in U.S. Pat. No. 5,891,552, a particularly useful thermoplastic copolymer is ethylene-acrylic acid available commercially under the trade name Michem, particularly Michem-4983, by Michelman Corporation. Ethylene-acrylic acid is, typically, produced by high pressure copolymerization of ethylene and acrylic acid. When ethylene is copolymerized with acrylic acid, the molecular structure is significantly altered by the random inclusion of bulky carboxylic acid groups along the backbone and side chains of the copolymer. The carboxyl groups are free to form bonds and interact with any polymer substrate. Commercially available ethylene-acrylic acid copolymers are Primacor 4983 sold by Dow Chemical Co., an aqueous dispersion having 25% solids content and obtained from a reaction between 15 mole % acrylic and 85 mol % ethylene. Other acrylic emulsions are those sold under the name of Acrylic, particularly Acrylic 79XW318A, 89XWO55 and 90XW067 by Valspar Corporation.

The total amount of the binder can range from about 20% to about 80%, specifically about 30% to about 60% by weight based on the entire weight of the coating composition.

When a film surface is prepared to enhance its ability to receive indicia by electrostatic printing, especially involving the use of a liquid toner, treatments, primers and coatings similar to those described in U.S. Pat. No. 5,891,552 may be used. Particular treatments, primers and coatings to enhance electrostatic printing with liquid toners are described in U.S. Pat. No. 5,789,123.

Particular, coatings to enhance the printability of films are described in copending U.S. application Ser. No. 09/828,638, filed Apr. 6, 2001, and copending U.S. application Ser. No. 09/864,518, filed May 24, 2001.

Film coatings to enhance ink adhesion may comprise acrylic polymers which are either chemically linked to amino-functional groups or are blended with other polymers which contain amino-functional groups. Such amino-functional groups may include moieties such as primary amines, secondary amines, tertiary amines and quaternary ammonium salts.

The presence of amino-functional groups in the film coating is believed to promote adhesion of the coating to film surfaces, especially those film surfaces which are treated to increase the surface tension thereof, e.g., by corona, flame or plasma treatment. The presence of amino-functional groups in the coating may also promote adhesion of certain types of inks applied to the exposed coating surface.

Examples of acrylic polymers which are chemically linked to amino-functional groups include iminated acrylic polymers, such as those described in U.S. Pat. Nos. 5,662,985 and 3,705,076.

The iminated acrylic polymer can contain an acrylic polymer of methyl methacrylate, an alkyl acrylate or an alkyl methacrylate and an ethylenically unsaturated carboxylic acid that is reacted with an alkylene imine such as ethylene imine, or propylene imine. The iminated acrylic polymer may comprise a polymer of (1.) methyl methacrylate, (2.) alkyl methacrylate having 2 to 12, specifically 2 to 8 carbon, atoms in the alkyl group or an alkyl acrylate having 1 to 12, specifically 2 to 8 carbon atoms in the alkyl group, and (3.) an ethylenically unsaturated carboxylic acid that is reacted with an alkylene imine. This acrylic polymer may be prepared by conventional solution or bulk polymerization techniques in which the monomer, polymerization catalyst and solvents are charged into a polymerization vessel and heated to form a polymer of the desired molecular weight as indicated by the viscosity of the polymer and subsequently reacted with an alkylene imine. One method for preparing these acrylic polymers is provided in U.S. Pat. No. 3,705,076.

Examples of alkyl groups of the alkyl methacrylate include: ethyl, propyl, isopropyl, butyl, tert-butyl, hexylmethyl, 2-ethylhexyl, octyl and the like.

Examples of alkyl groups of the alkyl acrylates include: ethyl, propyl, butyl, isobutyl, propyl, hexyl, 2-ethylhexyl, octyl, nonyl, decyl, lauryl and the like.

Examples of typical ethylenically unsaturated acids include methacrylic acid, ethylacrylic acid, acrylic acid, itaconic acid and the like.

Any of the alkylene imines mentioned in U.S. Pat. No. 3,705,076 can be used to iminate the acrylic polymers. Specific examples include ethylene imine and propylene imine which may be used in amounts of about 4 to 6% by weight of the acrylic polymer.

Examples of iminated acrylic polymers have (1.) 70 to 90% by weight methyl methacrylate, (2.) 9 to 19% by weight of the C₂ to C₁₂ alkyl acrylate, and (3.) 1 to 11% by weight of either acrylic acid or methacrylic acid reacted with about 1 to 8% by weight of an alkylene imine. Iminated acrylic polymers may also have (1.) 78 to 82% by weight of methyl methacrylate, (2.) 9 to 17% by weight of ethyl acrylate, (3.) 5 to 9% by weight of methacrylic acid reacted with about 4 to 6% by weight of alkylene imine. Particular acrylic polymers may consist essentially of methyl methacrylate/ethyl acrylate/methacrylic acid in a weight ratio of 80/13/7 and is reacted with 4 to 5% by weight of propylene imine.

Less than all of the acid functionalities (i.e. —COOH groups) of the acrylic base polymer may be reacted with imines. Accordingly, the iminated acrylic polymer may include acid functionalities (i.e. —COOH groups) or anions thereof. Such polymers may be referred to as anionic iminated acrylic polymers.

Anionic iminated polymers are commercially available from Zeneca Resins under the product designation “Neocryl” such as “Neocryl XK-90” and “Neocryl XA-5090”.

Another type of polymer coating containing an acrylic polymer and amino-functional groups is a cationically stabilized emulsion polymer that comprises on a dry basis:

i) 30 to 97 wt. % of at least one vinylic, non-acidic monomer which is uncharged or positively charged in an aqueous solution having a pH between 1 and 8; and

ii) 3 to 70 wt. % of at least one water-soluble polymeric compound having a number-average molecular weight greater than 5000 which comprises a moiety selected from the group consisting of primary amines, secondary amines, tertiary amines and quaternary ammonium salts.

For present purposes, the term “cationically stabilized emulsion” relates to emulsions containing a polymer having positive charges along its backbone, which are generally associated with negatively charged counterions like Cl⁻, Br⁻, NO₃⁻, SO₄⁻², RCO₂⁻ derived from inorganic or organic acids of relatively low molecular weight. However, where such positively charged polymers are mixed with another polymer having anions on the polymer backbone, the two polymers will coagulate. Moreover, if the localized pH around the cationic polymer exceeds 8.0, “kick out” or coagulation of the polymer will occur. Accordingly, it is important that these materials be prepared in an environment that minimizes exposure to anionic polymer.

The vinylic, non-acidic monomer includes at least one acrylic monomer, such as those selected from the group consisting of acrylic acid ester of C₁ to C₈ alcohol and methacrylic acid ester of C₁ to C₈ alcohol. The vinylic, non-acidic monomer may also include at least one monomer selected from the group consisting of acrylonitrile, methacrylonitrile, acrylamide, methacrylamide, N-substituted acrylamide, N-substituted methacrylamide, N-vinyl lactam, vinyl pyrrole, epoxy-functional vinyl compound, halogenated vinyl compound, vinyl monomer having a vinyl ester of an up to C₆ saturated aliphatic monocarboxylic acid, vinyl ether, alkyl vinyl ketone, diester of alpha, beta-unsaturated dicarboxylic acid, butadiene, and styrene.

The C₁ to C₈ alcohol can be unsubstituted or it may comprise an additional moiety selected from the group consisting of halogen, hydroxyl, amino, aziridino, alkoxy, and epoxy. The epoxy-functional vinyl compound can be selected from the group consisting of 3,4-epoxy-1-butene, and 2-X-3,4-epoxy-1-butene, where X is selected from the group consisting of fluoride, chloride, and bromide.

Examples of water-soluble polymeric compounds are described in U.S. Pat. No. 3,719,629. Such polymers include an acidified aminoethylated interpolymer having pendant amino alkylate groups of the general formula: CO₂(CHR₁CHR₂NH)ₙH, where R₁ and R₂ are selected from the group consisting of hydrogen and lower alkyl radicals comprising one to six carbon atoms, where the average value of n ranges from about 1.0 to 2.5.

A particular example of a water-soluble polymeric compound is NK7000 (a 49% solution of an amino-functional styrenated acrylic polymer with a number-average molecular weight of about 10,000 daltons and a weight-average molecular weight of about 25,000 daltons, containing a mixture of primary and secondary amines (manufactured by Nippon Shokubai Co., Ltd., Tokyo, Japan).

Another particular example of a water-soluble polymeric compound is poly(diallyldimethyl ammonium chloride), available as a 40% aqueous solution under the designation 261 RV from Calgon Corporation of Naperville, Ill., having a M_{w}˜200,000 to 350,000 daltons.

Solvent resistance of the coating may be improved by cross-linking at least a portion of polymers in the coating. Such solvent resistance includes resistance to degradation caused by water or alcohol, such as isopropyl alcohol.

Cross-linking of anionic iminated acrylic polymers may be accomplished with a cross-linking agent selected from the group consisting of polyfunctional aziridine, epoxy silane, polyfunctional epoxy, polyvalent cation selected from the group of metal ions consisting of Zr, Zn, Ca, and Ti, acetoacetate, carbodiimide, polyfunctional isocyanate, urea formaldehyde and melamine formaldehyde. Particularly suitable cross-linking agents include those selected from the group consisting of epoxy silane, polyfunctional epoxy, and melamine formaldehyde.

The cross-linking agent may be added with a cross-linking catalyst. Such catalysts are known to those skilled in the art. Amine catalysts are preferred for epoxy crosslinking agents, preferably DMP-30 or imidazoles. Acid catalysts are preferred for formaldehyde resins, preferably p-toluene sulfonic acid.

The weight ratio of cross-linking agent: anionic iminated acrylic polymer can range from about 0.5:100 to 10:100, preferably 1:100 to 5:100, more preferably 1:100 to 3:100. The weight ratio of catalyst : cross-linking agent can range from about 0.1:100 to 10:100, preferably 0.5:100 to 5:100, more preferably 1:100 to 3:100.

Solvent resistance for coatings including the above-mentioned cationically stabilized emulsion polymers may be improved by including functional groups in the polymers to promote self cross-linking. For example, the vinylic, non-acidic monomer may include an epoxy-functional monomer. Particular epoxy-functional monomers, which promote self cross-linking include glycidyl acrylate and glycidyl methacrylate (GMA). The water-soluble polymeric compound is present in an amount sufficient to stabilize an emulsion of the polymer and react with the epoxy-functional monomer when the emulsion is dried. The ratio of epoxy equivalents to reactive amine hydrogen equivalents in self-curing polymer may be, for example, between 1:1 and 1:3, e.g., between 1:1.5 and 1:2.5.

The cationic polymer of the cationically stabilized emulsion polymer can be, optionally, cross-linked with a separate cross-linking agent, even if the acrylic polymer has functional groups to promote self cross-linking. The cross-linking agent may be selected from the group consisting of polyfunctional aziridine, epoxy silane, polyfunctional epoxy, polyfunctional isocyanate, urea formaldehyde and melamine formaldehyde. Particularly suitable cross-linking agents include epoxy silane, polyfunctional epoxy, and melamine formaldehyde.

The cross-linking agent may be added with a cross-linking catalyst. Such catalysts are known to those skilled in the art and many are listed by Steiner et al. in U.S. Pat. No. 4,214,039. Particular amine catalysts include Ancamine® K54 (Tris-2,4,6-[dimethylaminomethyl] phenol) and Imicure® EMI-24 (2-ethyl-4-methyl-1H-imadazole) manufactured by Air Products and Chemicals, Inc. To avoid coagulation of the cationic emulsion, one should dilute these amine catalysts with water to about 1% before adding them to the emulsion. Alternatively, the amine catalysts can be diluted to about 10% solutions that have had the pH lowered to <8 with a mineral acid like HCl or an organic compound like acetic acid. Acid catalysts are preferred for formaldehyde resins, preferably p-toluene sulfonic acid.

UV curable inks usually have acrylic functionalities, which undergo photoinitiated polymerization reactions during the curing process. To promote adhesion of such UV curable inks to a film coating, the film coating may also comprise acrylic functionalities.

To promote ink adhesion to coatings of anionic iminated acrylic polymers, especially cross-linked anionic iminated acrylic polymers, such polymers may be reacted with an epoxy acrylate. Such epoxy acrylates may be made by addition of unsaturated acid, such as acrylic acid, to mono, di and/or poly epoxy compounds. Preferably the epoxy acrylate compounds can be the reaction product of an ether containing a three member oxirane ring, e.g., a glycidyl ether, of a member selected from the group consisting of phenols, bisphenols, ring substituted bisphenols, resorcinol, hydroquinone, adipic acid, phthalic acid, hexahydrophthalic acid, 2-hydroxy-3-chloropropyl acrylate, allyl alcohol, phenol, 1,6-hexanediol, glycerol, phenol formaldehyde novolac resins, polyethylene glycol, polypropylene glycol, ethylene glycol, propylene glycol, 1-4 butanediol, 1-6 hexanediol glycerol, glycol, lower alkyl substituted hydantoin and mixtures thereof; and an unsaturated acid selected from the group consisting of acrylic acid and methacrylic acid, diacrylic acid, dimethylacrylic acid, triacrylic acid and trimethylacrylic acid. Epoxy acrylate which is the reaction product of a glycidyl ether of a member selected from the group consisting of polyethylene glycol and polypropylene glycol; and an unsaturated acid selected from the group consisting of acrylic acid and methacrylic acid, is preferred. Especially preferred is the reaction product of a glycidyl ether polypropylene glycol; and an unsaturated acid, which is acrylic acid. The molar ratio of epoxy groups to unsaturated acid is preferably 1 or close to 1.

Suitable epoxy acrylates are available from Nagase Chemicals, Ltd., Tatsuno City, Hyogo, Japan under the tradename “Denacol Acrylate” UV or EB Curable Resin. Specific products include “DM-8 11” (epoxy methacrylate from (poly)ethylene glycol); “DA-9 11” (epoxy acrylate from (poly)propylene glycol); and “DA-911M” (epoxy acrylate from (poly)propylene glycol).

Under conditions where the epoxy acrylate may self-react, e.g., long storage periods or high storage temperatures, it is advisable to stabilize the epoxy acrylate by the incorporation of a suitable stabilizer, e.g., one selected from the group consisting of methyl ether of hydroquinone, and hydroquinone with methyl ether of hydroquinone being preferred.

To promote adhesion of inks to coatings made from the above-mentioned cationically stabillized emulsion polymers, the vinylic, non-acidic monomer component may a nitrogen-containing monomer, e.g., a nitrogen-containing monomer selected from the group consisting of acrylonitrile and methacrylonitrile.

The preparation of a particular example of an anionic iminated acrylic coating composition may be formed by combining 5192 g of anionic acrylic polymer (NeoCryl XK-90 resin) with 12288 g of water, dilute ammonium hydroxide in an amount to adjust the pH to 8.0, 140 g of Epostar MA 1006 (dispersed at 5% solids) (0.3 parts per hundred based on acrylic polymer), 23.4 g of methyl ether of hydroquinone (MEHQ), 1% in water (0.01 phr), 29 g of cross-linking agent (NeoRez CX100, a polyfunctional aziridine, available from Zeneca Resins) (1.25 phr), and 327 g of epoxy acrylate (DA-911M) (14 phr) (Total phr=115.56). Epostar MA 1006, a cross-linked acrylic particulate dispersed at 10% solids. Epostar MA 1006 is an anti-block/coefficient of friction reducing additive made from methyl methacrylate resin having an average diameter of about 6 microns and is commercially available from Nippon Shokubai. The ingredients may be added in the order listed with stirring and stirred at least 30 minutes at ambient temperature.

This coating composition prepared by this procedure may be top coated on a corona treated film surface at a topcoat oven temperature of 180° F. to give a 0.80 g/msi (g/1000 in²) target coat weight at 125 feet per minute, using an 85 reverse direct Quad Gravure, and 19% top coating.

The preparation of a particular example of a cationically stabilized emulsion polymer coating composition was formed using a semi-continuous batch process. A latex was prepared by continuously adding and metering 3510 grams of total monomer (consisting of 1580 grams methyl acrylate, 880 grams butyl acrylate, 700 grams acrylonitrile and 350 grams GMA) over 2.25 hours to a stirred reactor containing 3500 grams deionized water, 200 grams NK7000, 10 grams 30% hydrogen peroxide, and 12 grams 10N hydrochloric acid. A feed containing 500 grams deionized water, 0.3 grams ferrous sulfate heptahydrate, and 10 grams ascorbic acid was metered in over 2.75 hours. This feed was started after the oxygen had been removed from the reactor by a vacuum pump and padded with nitrogen, heated to about 60° C., and 350 grams of the monomer mixture were charged to the jacketed, glass-lined pressure vessel manufactured by Pfaudler. The agitation was set at 150 rpm. The temperature set point was 65° C. About 5-10 minutes after the activator feed was started, the monomer feed was started (at which time the initial exotherm had ended). Fifteen minutes after the activator feed was started, the stabilizer feed (consisting of 800 grams NK7000 and 1400 grams deionized water) was started and metered in over about two hours, ending at about the same time as the monomer feed. Deionized water was used to flush all the feed lines. After the activator feed was in, solution that contained 2 grams 2,2′-azobisisobutyronitrile dissolved in 40 grams methanol was injected into the reactor. The temperature was held at 65° C. for another hour, and then the batch was cooled.

The resultant polymer was 37.9% solids about 87.5% of which was the acrylic copolymer (consisting of 45% methyl acrylate, 25% butyl acrylate, 20% acrylonitrile, and 10% GMA) and 12.5% was NK7000. The finished batch had no observable coagulum and about 1 gram wet grit was removed by filtration through a 115-micron screen. It had a viscosity of 23 centipoise. The pH was about 3.1, and the intensity-weighted particle size was about 0.093 microns. The emulsion had a mild odor characteristic of methyl acrylate.

With this composition the ratio of active amine hydrogens to epoxy groups derived from GMA is about 2:1. The theoretical glass transition temperature is about 8° C. prior to the onset of cross-linking.

This coating composition prepared by this procedure may be top coated on a corona treated film surface with 200Q gravure and dried at 115° C. The composition may be adjusted to pH 6.5-7.0 with 1% Imicure® EMI-24 (in water) and diluted to 6.5% solids. The dried coating weight for all coatings may be about 0.1 g/msi.

A variety of ink types may be used in ink jet printing processes. As discussed in U.S. Pat. No. 6,310,115, ink compositions for ink jet printing typically include following ingredients: dyes or pigments, water and/or organic solvents, humectants such as glycols, detergents, thickeners, polymeric binders, preservatives, etc. It will be readily understood that the optimal composition of such an ink is dependent on the ink jetting method used and on the nature of the substrate to be printed. The ink compositions can be roughly divided into the following categories: water based—the drying mechanism involves absorption, penetration and evaporation; oil based—the drying involves absorption and penetration; solvent based—the drying mechanism involves primarily evaporation; hot melt or phase change—the ink vehicle is liquid at the ejection temperature but solid at room temperature—drying is replaced by solidification; and UV-curable—drying is replaced by polymerization.

It will be readily understood that the first two types of ink compositions require a receiving medium that is more or less absorptive. On the contrary, for non-absorbent substrates, solvent based inks, hot melt inks or UV-curable inks will be better suited.

UV-curable inks are particularly suited for printing colored polyolefin films. On the other hand, the above-mentioned water based inks are rather unsuited for ink jet printing of such films due to slow drying of the ink.

A highly opaque ink jet UV ink can be printed on colored polyolefin film to give a desired appearance. For example, when the polyolefin film has an opacified core with a colored skin or tie layer, e.g., as per the film depicted in FIG. 3, the ink jet printed film may manifest a 3-D effect, as described above, wherein the printed image appears to float on top of the film surface.

Continuous webs or rolls of colored polyolefin films may be continuously printed in a system involving UV ink jet printing, where the images provided by the ink jet printer are digitally controlled. Variable images, corresponding to variable digital data, can be continuously printed using this system. Due to fast curing of the ink, print speed can be fast.

In conventional printing operations, rolls of film are (1) unwound, (2) printed and then (3) rewound. The rewound printed films may then be passed on to separate lines for other operations, such as packaging or labeling.

The UV ink jet printing can be done in-line on a packaging or label line, wherein unprinted film is unwound, printed without being rewound into a roll and then passed to the packaging or labeling section of the line. In addition to printing the film on a separate processing line, e.g., for packaging or labeling, the film may be first partially printed on a conventional printing line, e.g., to supply color accent.

It is also possible to use digital UV ink jet printing in a system where a colored polyolefin film is extruded and printed in a single line operation. According to such a system, the extruded film passes from extrusion and orientation stages through stages of (1) printing with a UV curable ink jet ink and (2) curing of the applied ink by exposing the printed film to a UV light source, wherein the printing and curing stages take place before the film is first wound into a roll.

The printed film may, optionally, be over-coated with a protective layer such as a heat resistance lacquer layer.

What is claimed is:

1. A method for printing a polyolefin film comprising the steps of:
(a) blending a coloring agent with a polyolefin;
(b) extruding said blend of step (a) onto a casting roll to form a colored extruded film;
(c) orienting said colored extruded film of step (b) in at least one direction to form an oriented film;
(d) passing said oriented film of step (c) to a digital printer; and
(e) passing a digital signal to said digital printer to cause indicia to be placed on the surface of said oriented film.

2. A method according to claim 1, wherein said digital printer is an ink jet digital printer.

3. A method according to claim 2, wherein said ink jet digital printer applies UV curable ink to said oriented film, and wherein said UV curable ink is cured by applying ultraviolet light to the ink jet printed film.

4. A method according to claim 3, which is conducted in a continuous in-line operation, wherein the extruded film of step (b) is maintained in web form without being wound up into a roll until after said UV ink is cured.

5. A method according to claim 3, wherein steps (a), (b) and (c) are conducted in a single line operation where a roll of unprinted film is produced.

6. A method according to claim 5, wherein steps (d) and (e) are conducted in a single packaging or labeling line operation, wherein said roll of unprinted film is unwound; steps (d) and (e) are conducted to form a printed, unwound film; and the printed, unwound film is converted into packages or labels without being rewound into a roll of printed film.

7. A method according to claim 1, wherein steps (a) and (b) comprise:
(i) coextruding a colored skin layer comprising a polyolefin blended with a coloring agent adjacent to an opaque core layer comprising polypropylene and a cavitating agent;
(ii) orienting said colored skin layer and said opaque core layer in the machine direction; and
(iii) orienting said colored skin layer and said opaque core layer in the transverse direction, and wherein indicia is placed on the surface of said colored skin layer in step (e).

8. A method according to claim 1, wherein steps (a) and (b) comprise:
(i) coextruding a skin layer comprising a polyolefin, a colored transition layer comprising a polyolefin blended with a coloring agent, and an opaque core layer comprising polypropylene and a cavitating agent, wherein said colored transition layer is between said skin layer and said opaque core layer;
(ii) orienting said skin layer, said colored transition layer and said opaque core layer in the machine direction; and
(iii) orienting said skin layer, said colored transition layer and said opaque core layer in the transverse direction, and wherein indicia is placed on the surface of said skin layer in step (e).

9. A method according to claim 1, wherein the film is coated with a print enhancing coating prior to step (d).

10. A method according to claim 9, wherein the film is coated with a primer prior to being coated with said print enhancing coating.
